(19) United States
(12) Patent Application Publication
(10) Pub. No.: US 2011/0043019 A1
(43) Pub. Date: Feb. 24, 2011

(54) VEHICLE SEAT

(75) Inventors: Stefan Flucht, Gaufelden (DE); Stuart Soolston, Glasgow (GB); Peter Szegeny, Leverkusen (DE); Frank Gerhardt, Koln (DE)

Correspondence Address: Johnson Controls, Inc.;c/o Fletcher Yoder PC, P.O. Box 692289, Houston, TX, 77269, US

(73) Assignee: Johnson Control Technology Company, Holland, MI (US)

(21) Appl. No.: 12/745,242

(22) PCT Filed: Nov. 14, 2008
(86) PCT No.: PCT/EP08/09629

§ 371 Date: Oct. 28, 2010

(30) Foreign Application Priority Data
Dec. 6, 2007 (DE) 10 2007 059 184.7
Feb. 25, 2008 (DE) 10 2008 010 926.6

(51) Int. Cl. B60N 2/20

(52) U.S. Cl. 297/354.1

(57) ABSTRACT

A vehicle seat has a backrest that includes a user support surface and a structural part. The user support surface is configured to be adjusted at least partially relative to the structural part to a first position corresponding to a use position and to a second position corresponding to a stowage position. First and second partial surfaces of the backrest may be separately displaceable.

### CROSS REFERENCE TO RELATED APPLICATIONS

This application claims priority from and the benefit of PCT Application No. PCT/EP2008/009629, filed on Nov. 14, 2008; German Patent No. DE 10 2007 059 184.7, filed on Dec. 6, 2007; and German Patent DE 10 2008 010 926.6, filed on Feb. 25, 2008; all entitled “Vehicle Seat”, which are herein incorporated by reference.

### BACKGROUND

The present invention relates to a vehicle seat having a backrest, the backrest comprising a user support surface and a structural part. In particular, the present invention relates to the middle seat of a row of seats, in particular of a multi-part rear seat bench.

Such vehicle seats are sufficiently known from the prior art.

### SUMMARY

It was the object of the present invention to develop the kinematics of this vehicle seat and/or to reduce as far as possible the dimensions thereof in the stowage position.

The object is achieved by a vehicle seat having a backrest, the backrest comprising a user support surface and a structural part, the user support surface being able to be adjusted at least partially relative to the structural part to a first position corresponding to a use position and to a second position corresponding to a stowage position. Moreover, the object is achieved by a vehicle seat having a backrest, the backrest comprising a user support surface and a structural part, the backrest comprising a first subsection and a second subsection, a first partial surface corresponding to the region of the user support surface associated with the first subsection and a second partial surface corresponding to the region of the user support surface associated with the second subsection, the second partial surface in the second position being provided displaced relative to the second partial surface in the first position, in a direction substantially perpendicular to the second partial surface. The vehicle seat according to the invention may be produced in a simple manner and cost-effectively and has very compact dimensions in its stowage position. The transfer of the vehicle seat according to the invention from the use position into the stowage position and vice versa may be carried out by the user in a simple manner and by a small expenditure of force. In the seat according to the invention, it is provided that at least one subsection of the backrest is provided to be able to be altered with regard to its thickness. It is provided, in particular, to form at least one, preferably lower, subsection of the backrest from a front element and a rear element which are connected to one another by an adjusting mechanism, in particular by using at least one four bar linkage. In the upright use position of the backrest, the adjusting mechanism is in the extended position, preferably by the use of springs, so that the subsection of the backrest has a relatively large thickness. When folding forward the backrest, the front and rear elements are moved toward one another whereby the thickness of the subsection of the backrest is reduced. Particularly advantageously, therefore, a further, preferably upper, subsection of the backrest is pushed over the now contracted, lower subsection of the backrest, whereby the height of the backrest is also reduced. The aforementioned front element of the backrest is preferably provided with a seat cover and/or upholstery, whilst the rear element may be configured to be unupholstered. The vehicle seat according to the invention is suitable, in particular, for being produced with a vehicle seat disclosed in the publication DE 10 2007 055 082 and/or being incorporated in such a vehicle seat. Reference is expressly made to this publication and the disclosure thereof—in particular with regard to all measures and features for producing a shortening of the backrest when folding down the backrest—is included, therefore, by way of reference in the disclosure of the present invention.

According to the invention, it is particularly preferred that the first partial surface in the second position is provided displaced relative to the first partial surface in the first position, in a direction substantially parallel to the first partial surface. As a result, in a particularly simple manner a shortening of the backrest is implemented when the backrest is folded down to the front. In particular, according to the invention the displacement of the first partial surface is only provided when the displacement of the second partial surface into the second position has already been substantially completed, i.e. when the second partial surface is provided displaced in a direction substantially perpendicular to the second partial surface (relative to its first position).

Moreover, it is provided according to the invention that the displacement of the second partial surface is provided by means of an adjusting mechanism, in particular by the pivoting of a four bar linkage between the second subsection and the structural part, and/or that a drive element is provided for controlling the displacement of the second partial surface and/or the drive element comprises a slotted link and is operatively connected, in particular, to the four bar linkage. As a result, according to the invention the lower part (second subsection) of the backrest may advantageously contract and/or be reduced in thickness in a particularly simple and reliable manner.

According to the invention, it is further preferred that the first partial surface and the second partial surface in each case comprise a visible side, the visible sides being provided separately from one another, in particular not having a common cover. As a result, according to the invention it is possible to achieve in a manner which is simple yet aesthetically attractive in a normal use situation of the vehicle seat a considerable reduction in the constructional space of the vehicle seat—in particular a middle seat of a vehicle rear seat bench. In particular, the reduction in constructional space according to the invention is not associated with the unattractive formation of folds of a cover (which is at least partially continuous and/or in one piece), which is applied both to the first subsection of the backrest and to the second subsection of the backrest.

According to the invention, it is further particularly preferred that the vehicle seat comprises a seat part, the backrest being provided to be pivotable relative to the seat part, in a position of the backrest folded in the direction of the seat part (the stowage position), both the second partial surface being provided adjusted in the second position and the first partial surface being provided adjusted in the second position. As a result, according to the invention the stowage position of the vehicle seat may be adopted in a particularly simple manner.

### DRAWINGS

The figures represent by way of example and schematically an embodiment of the invention.

FIGS. 1 to 4 show schematically and in a perspective view in each case a first and/or a second subsection of a backrest for a vehicle seat according to the invention.

FIGS. 5 and 6 show schematically the second subsection of the backrest for a vehicle seat according to the invention in two different positions.

FIG. 7 shows schematically a detailed view for adjusting the position of the second subsection.

FIGS. 8 to 12 show schematically and in side view various adjusted positions of the backrest of the vehicle seat according to the invention.

### DETAILED DESCRIPTION

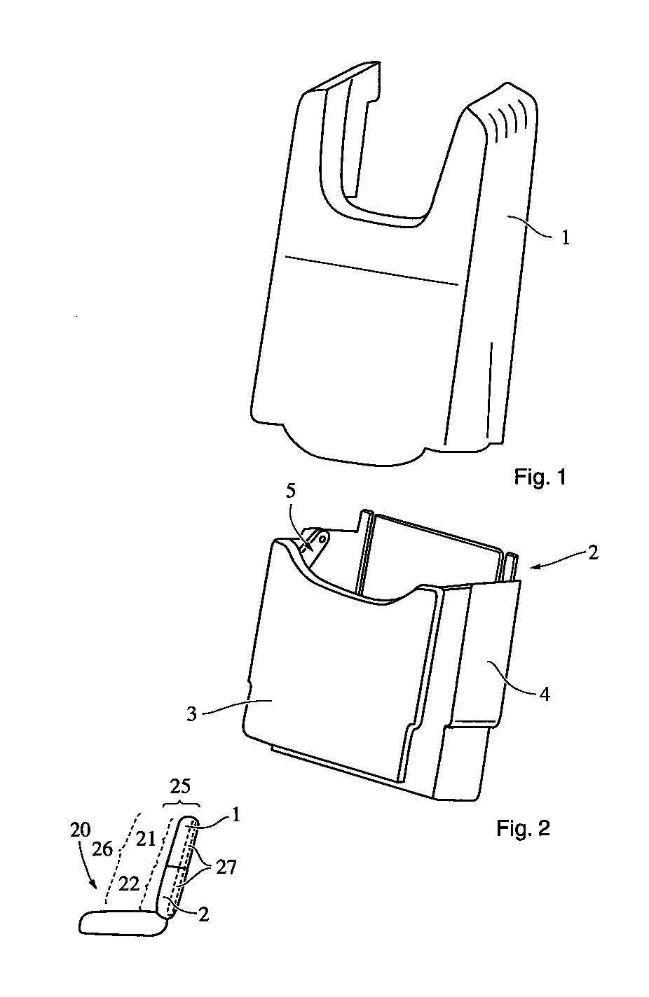

FIGS. 1 and 3 show the upper subsection 1 and/or the first subsection 1 of a backrest for a vehicle seat according to the invention. The first subsection is, for example, configured as a hollow body upholstered on the front side and open at the bottom. FIGS. 2 and 4 show the lower subsection 2 and/or the second subsection 2 of the backrest for the vehicle seat according to the invention. As is visible from FIGS. 2 and 4, the lower (and/or second) subsection 2 consists of a front, upholstered, shell-like element 3 and a rear, hard, shell-like element 4, which are connected to one another in an adjustable manner via an adjusting mechanism 5. As is shown in the lower part of FIG. 2, the backrest 25 of the vehicle seat 20 according to the invention has a user support surface 26 (and/or support surface for the back of a user). The vehicle seat 20 further has a structural part 27 (merely illustrated by dotted lines in the lower part of FIG. 2). Within the scope of the present invention the user support surface 26 in the region of the first subsection 1 is denoted as the first partial surface 21 and the user support surface 26 in the region of the second subsection 2 is denoted as the second partial surface 22. According to the invention, for adopting the stowage position of the vehicle seat 20, for example, the second partial surface 22 is displaced and/or adjusted substantially perpendicular to the extension of the second partial surface 22 and for adopting the stowage position the first partial surface 21 is displaced and/or adjusted substantially parallel to the extension of the first partial surface 22 (by, for example, the first subsection 1 being moved over the second subsection 2 which is reduced in its thickness. The front shell-like element 3 of the second subsection 2 has on its front side the second partial surface 22. The rear, in particular shell-like, element 4 of the second subsection 2 is, in particular, part of the structural part 27 of the backrest 25.

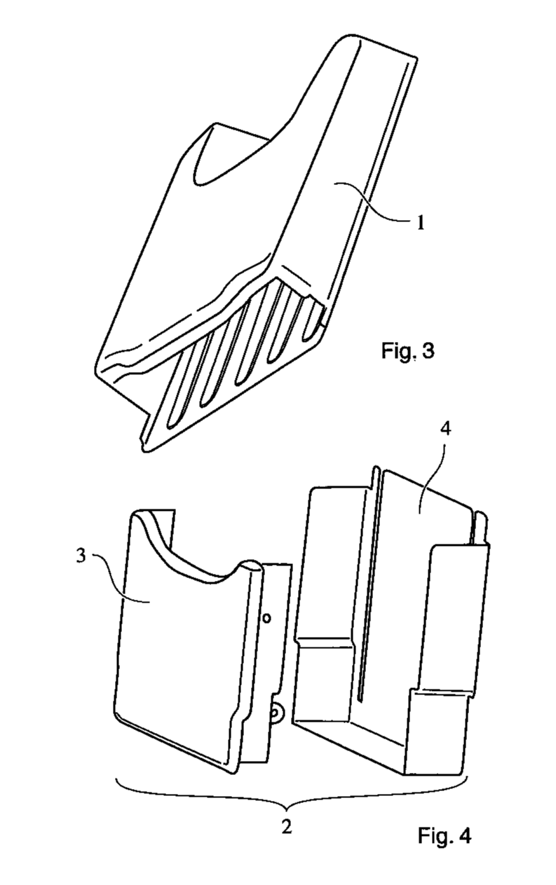

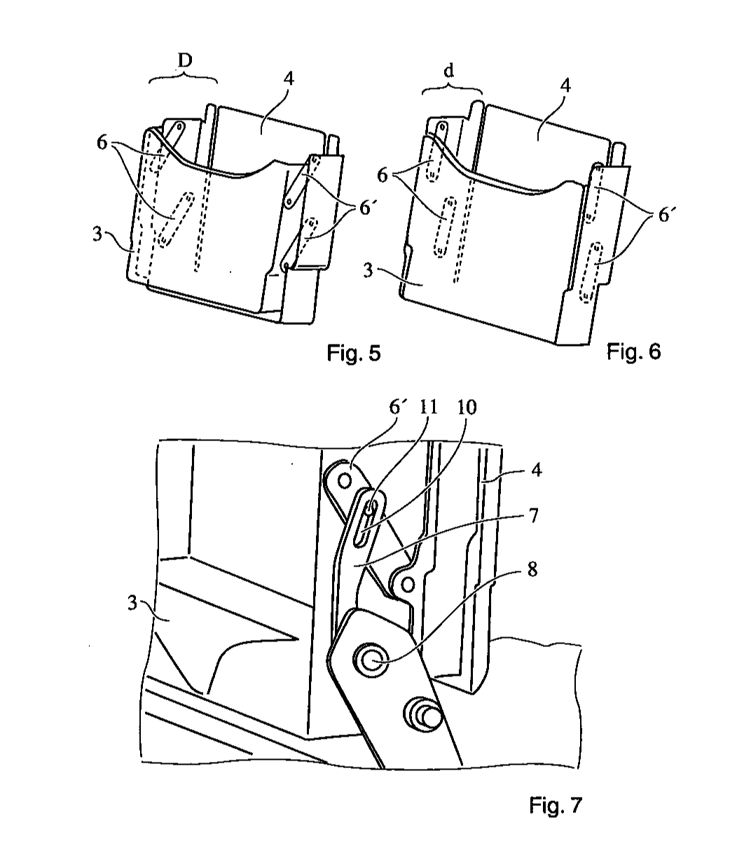

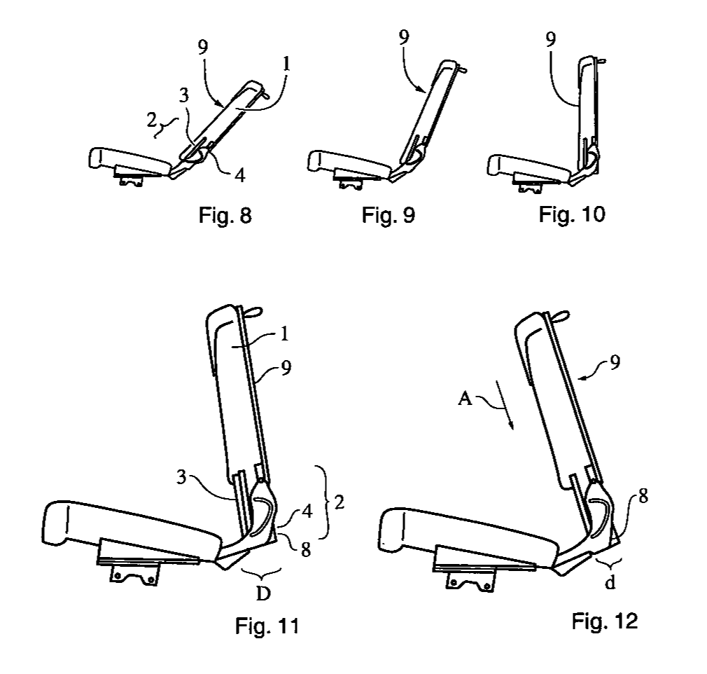

As shown in FIGS. 5 to 7, the adjusting mechanism 5 has two four bar linkages 6, 6′ by means of which the thickness of the subsection 2 may be reduced from a (greater) thickness D to a (smaller) thickness d. The four bar linkages 6, 6′ are thus controlled via a drive element 7 such that the thickness D of the subsection 2 remains unaltered between a rear comfort position (FIG. 8) via the design position (FIG. 9) to a position (FIGS. 10, 11) slightly inclined to the front. The drive element 7, in the meantime, freely rotates in the articulation 8 of the backrest 9, fixedly relative to the four bar linkages 6, 6′.

Only when the backrest 25 is pivoted further to the front (FIG. 12) does the lower subsection 2 contract to the thickness d, so that the upper subsection 1 may be pulled in the direction of the arrow A over the lower subsection 2. The contraction and/or reduction in thickness of the second and/or lower subsection 2 takes place by the drive element 7 adopting its front pivoting position and, with a further folding forward of the backrest 9, rotating to the rear relative to the four bar linkages 6, 6′. This displacement is transmitted to the four bar linkages 6, 6′ by a slotted link 10 in the drive element 7 and a bolt 11 engaging therein.

According to the invention, it is particularly preferred that, by means of a cover, the first subsection 1 and the second subsection 2 may be provided separately from one another, so that the shortening of the length of the backrest 25 is possible without an unattractive fold arrangement or a similar unattractive appearance.

1. A vehicle seat having a backrest, the backrest comprising a user support surface and a structural part, wherein the user support surface is configured to be adjusted at least partially relative to the structural part to a first position corresponding to a use position and to a second position corresponding to a stowage position.

2. The vehicle seat as claimed in claim 1, wherein the backrest comprises a first subsection and a second subsection, a first partial surface corresponding to a region of the user support surface associated with the first subsection, and a second partial surface corresponding to a region of the user support surface associated with the second subsection, the second partial surface in the second position being displaced relative to the second partial surface in the first position, in a direction substantially perpendicular to the second partial surface.

3. The vehicle seat as claimed in claim 2, wherein the first partial surface in the second position is displaced relative to the first partial surface in the first position, in a direction substantially parallel to the first partial surface.

4. The vehicle seat as claimed in claim 2, wherein the displacement of the second partial surface is provided by means of an adjusting mechanism between the second subsection and the structural part.

5. The vehicle seat as claimed in claim 2, wherein a drive element is provided for controlling the displacement of the second partial surface.

6. The vehicle seat as claimed in claim 5, wherein the drive element comprises a slotted link.

7. The vehicle seat as claimed in claim 2, wherein the first partial surface and the second partial surface each comprise a visible side, the visible sides being provided separately from one another.

8. The vehicle seat as claimed in claim 2, wherein the vehicle seat comprises a seat part, the backrest being pivotable relative to the seat part, and wherein in the stowage position the backrest is folded in the direction of the seat part, and wherein the second partial surface is adjusted in the second position and the first partial surface is adjusted in the second position.

9. The vehicle seat as claimed in claim 4, wherein the adjusting mechanism comprises a pivotable four bar linkage.

10. The vehicle seat as claimed in claim 6, wherein the slotted link is operatively connected to a four bar linkage.

11. The vehicle seat as claimed in claim 7, wherein the visible sides have no common cover.
